(19) United States
(12) Patent Application Publication
(10) Pub. No.: US 2019/0250542 A1
(43) Pub. Date: Aug. 15, 2019

(54) IMAGE FORMING APPARATUS

(71) Applicant: CANON KABUSHIKI KAISHA, Tokyo (JP)

(72) Inventors: Takeharu Nakada, Utsunomiya-shi (JP); Tomoo Akizuki, Kawasaki-shi (JP); Ryo Morihara, Tokyo (JP); Masahiko Suzumi, Yokohama-shi (JP)

(21) Appl. No.: 16/272,477

(22) Filed: Feb. 11, 2019

(30) Foreign Application Priority Data
Feb. 13, 2018 (JP) 2018-022967

(51) Int. Cl. G03G 15/20; G03G 15/00

(52) U.S. Cl. CPC G03G 15/2039; G03G 15/2028; G03G 2215/00603; G03G 2215/00599; G03G 15/657

(57) ABSTRACT

An image forming apparatus includes an image forming portion, a fixing portion, a temperature detecting portion, a measuring portion, a storing portion, and a controller. The controller is capable of setting a case that a start of feeding of a recording material is permitted after a lapse of a predetermined time need to measure a temperature rising rate of the fixing portion and a case that the start of feeding of the recording material is permitted, depending on a value relating to the temperature rising rate stored in the storing portion, at timing before the lapse of the predetermined time.

### FIELD OF THE INVENTION AND RELATED ART

The present invention relates to an image forming apparatus such as a copying machine using electrophotography or an electrophotographic printer.

Sheet feeding start timing when a print instruction in an image forming apparatus is received is set at timing which later one of exposure permission timing and fixing permission timing in general. Here, the exposure permission timing refers to timing when a rotation number of a scanner motor (polygon mirror driving motor) for scanning a photosensitive drum surface with laser light is not less than a predetermined rotation number determined in advance. Further, the fixing permission timing is timing when a temperature of a member constituting a fixing device for applying heat and pressure to toner in order to fix the toner on a recording material is not less than a predetermined temperature determined in advance.

In such an image forming apparatus, in order to make the temperature of the fixing device a fixable temperature as early as possible, energy supplied to a heater was made maximum.

On the other hand, the image forming apparatus in recent years has been required that a time from receipt of a print instruction until a first recording material is outputted (first printout time (FPOT)) is shortened. Accordingly, irrespective of a factor affecting a fixing property, it is desired that FPOT is shortened while ensuring a good fixing property.

In such an image forming apparatus, in order to shorten the FPOT, Japanese Laid-Open Patent Application (JP-A) 2013-160980 discloses that sheet feeding start timing is determined depending on a temperature rising rate (temperature rise speed) of the member constituting the fixing device in a predetermined time after the print instruction is received.

However, in JP-A 2013-160980, in order to estimate the sheet feeding start timing with accuracy, there is a need to ensure a predetermined time (necessary measuring time) in which the temperature rising rate of the member of the fixing device is measured. For that reason, it is difficult that the sheet feeding start timing is made earlier than timing of an end of the necessary measuring time, and therefore, there was a problem such that a time obtained by subtracting a recording material feeding temperature from the FPOT cannot be made shorter than the necessary measuring time.

### SUMMARY OF THE INVENTION

A principal object of the present invention is to provide an image forming apparatus capable of further shortening an FPOT from the viewpoint of usability.

According to an aspect of the present invention, there is provided an image forming apparatus comprising: an image forming portion configured to form a toner image on a recording material; a fixing portion configured to fix the toner image on the recording material by heating the toner image formed on the recording material; a temperature detecting portion configured to detect a temperature of the fixing portion; a measuring portion configured to measure, with the temperature detecting portion, a temperature rising rate of the fixing portion when the temperature of the fixing portion rises, upon receipt of a print instruction, to a predetermined temperature at which the toner image is fixable; a storing portion configured to store a value relating to the temperature rising rate measured by the measuring portion; and a controller configured to control feeding start timing of the recording material, wherein the controller is capable of setting a case that a start of feeding of the recording material is permitted after a lapse of a predetermined time need to measure the temperature rising rate and a case that the start of feeding of the recording material is permitted, depending on the value stored in the storing portion, at timing before the lapse of the predetermined time.

According to another aspect of the present invention, there is provided an image forming apparatus comprising: an image forming portion configured to form a toner image on a recording material; a fixing portion including a heater and configured to fix the toner image on the recording material by heating the toner image formed on the recording material; a temperature detecting portion configured to detect a temperature of the fixing portion; a measuring portion configured to measure, with the temperature detecting portion, a temperature rising rate of the fixing portion when the temperature of the fixing portion rises, upon receipt of a print instruction, to a predetermined temperature at which the toner image is fixable; a storing portion configured to store a value relating to the temperature rising rate measured by the measuring portion; and a controller configured to control feeding start timing of the recording material, wherein the controller is capable of setting a case that a start of feeding of the recording material is permitted after a lapse of a predetermined time from a start of supply of electric power to the heater in response to a print instruction and a case that the start of feeding of the recording material is permitted, depending on the value stored in the storing portion, at timing before the lapse of the predetermined time.

Further features of the present invention will become apparent from the following description of exemplary embodiments with reference to the attached drawings.

### BRIEF DESCRIPTION OF THE DRAWINGS

FIG. 1 is a sectional view of an image forming apparatus according to an embodiment of the present invention.

FIG. 2 is a schematic view of an exposure device (scanning portion) 3 in an image forming portion.

FIG. 3 is a sectional view of a fixing device 11.

FIG. 4 is a block diagram showing a relationship among a sheet feeding portion 15, the scanning portion 3 and a fixing device (fixing portion) 11 with a CPU (temperature controlling portion) of the image forming apparatus as a central portion in this embodiment.

FIG. 5 is a time chart for determining sheet feeding start timing of the image forming apparatus in First Embodiment.

FIG. 6 is a graph for illustrating a temperature rising rate of a detection temperature of a thermistor contacted to a back surface of a heater.

FIG. 7 is a correspondence table among a temperature rising rate ΔT, a power state, an estimated supplied power, a fixing device state and a time from receipt of a print instruction to arrival at fixing permission timing in a condition in which the image forming apparatus of First Embodiment is placed in a normal temperature (23° C.) environment and a plain paper mode.

FIG. 8 is a flowchart of a determining sequence of the sheet feeding start timing in the image forming apparatus of this embodiment.

FIG. 9 is a flowchart of a determining sequence of the fixing permission timing in the image forming apparatus of First Embodiment.

FIG. 10 is a flowchart of a determining sequence of fixing permission timing in an image forming apparatus of Comparison Example 1.

FIG. 11 is a table in which experiment results of the image forming apparatuses of Comparison Example 1 (“COMP. EX. 1”) and First Embodiment (“EMB. 1”) are summarized.

FIG. 12 is a flowchart of a determining sequence of fixing permission timing in an image forming apparatus of Second Embodiment (“EMB. 2”).

FIG. 13 is a flowchart of a voltage fluctuation countermeasure sequence in the image forming apparatus of Second Embodiment.

FIG. 14 is a graph showing a change in power source voltage with an elapsed time in Second Embodiment.

FIG. 15 is a flowchart of a determining sequence of sheet feeding start timing in an image forming apparatus of Third Embodiment.

FIG. 16 is a flowchart of a determining sequence of fixing permission timing in the image forming apparatus of Third Embodiment (“EMB. 3”).

FIG. 17 is a graph showing a change in power source voltage with an elapsed time in Third Embodiment.

FIG. 18 is a flowchart of a determining sequence of fixing permission timing in an image forming apparatus of Fourth Embodiment.

### DESCRIPTION OF EMBODIMENTS

Embodiments of the present invention will be specifically described with reference to the drawings. Dimensions, materials, shapes and relative arrangements of constituent elements described in the following embodiments should appropriately be changed depending on structures and various conditions of apparatuses to which the present invention is applied. That is, the scope of the present invention is not intended to be limited to the following embodiments.

### <First Embodiment>

### (Image Forming Apparatus)

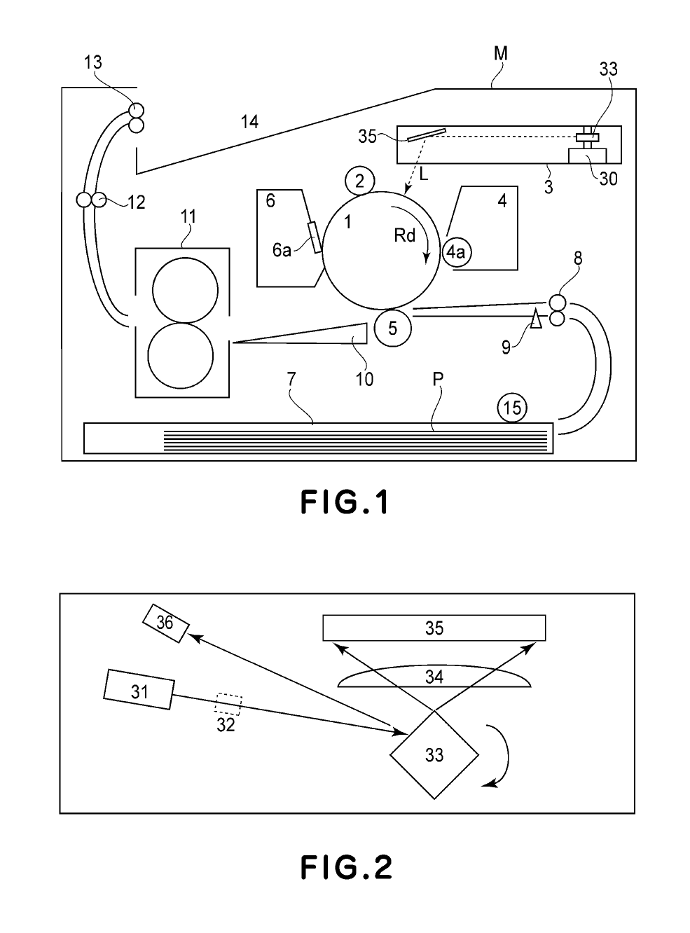

FIG. 1 is a schematic sectional view of an image forming apparatus according to an embodiment of the present invention.

In FIG. 1, a drum-shaped electrophotographic photosensitive member (hereinafter referred to as a photosensitive drum) 1 which is an image bearing member is rotatably supported by an apparatus main assembly M and is to be rotationally driven at a predetermined process speed in an arrow Rd direction by an unshown driving portion. At a periphery of the photosensitive drum 1, along a rotational direction of the photosensitive drum 1, a charging device 2, a scanning portion (exposure device) 3, a developing device 4, a transfer device (transfer portion) 5 and a cleaning device 6 are successively provided. The scanning portion 3 includes a scanner motor 30, a polygon mirror 33 and a reflecting mirror 35, and the developing device 4 includes a developing roller 4a. The cleaning device 6 includes a cleaning blade 6a.

These members constitute an image forming portion for forming a toner image on a sheet-like recording material P such as paper. Further, the photosensitive drum 1, the charging device 2, the developing device 4 and the cleaning device 6 may also be assembled into a single unit as a cartridge mountable to and dismountable from the apparatus main assembly M.

A sheet feeding cassette 7 is provided at a lower portion of the apparatus main assembly M and the recording material P is accommodated therein. The roller P is fed along a feeding pat in the order of a sheet (paper) feeding portion 15, a feeding roller pair 8, a top sensor 9, the transfer device 5, a metal plate-like feeding guide 10, a fixing device (fixing portion 11, a feeding roller pair 12, a sheet discharging roller pair 13 and a sheet discharge tray 14 from an upstream side.

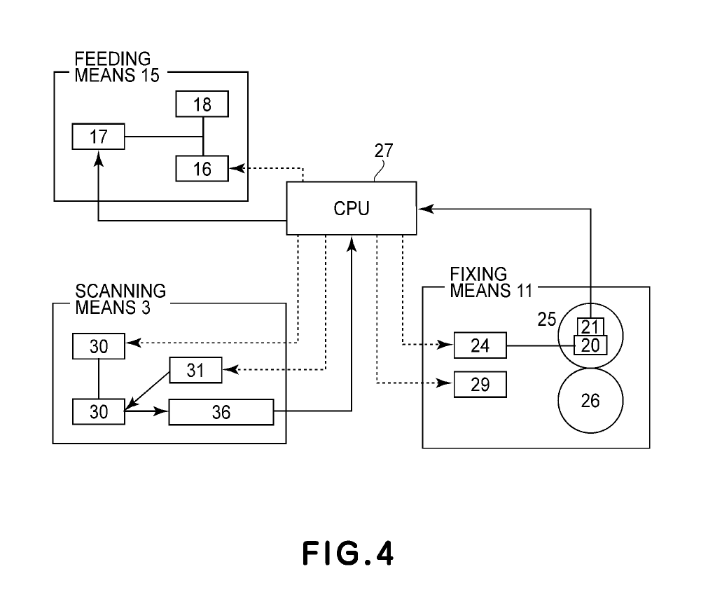

The sheet feeding portion 15 includes, as shown in FIG. 4, a sheet feeding roller 18 driven by a main motor 16 of the apparatus main assembly and a solenoid 17 for switching power transmission between the main motor 16 and the feeding roller 18. The main motor 16 also drives the photosensitive drum 1, the developing roller 4a, the feeding roller pair 8, and the like.

FIG. 2 is a schematic view of the scanning portion (exposure device) 3. An optical box of the scanning portion 3 includes a light source 31 for emitting laser light L modulated depending on image information, a collimator lens 32 for changing the laser light L emitted from the light source 31 into parallel (collimated) light, and the polygon mirror 33 for deflecting the laser light L. The optical box further includes the scanner motor 30 (the polygon mirror driving motor shown in FIG. 1) to which the polygon mirror 33 is attached, an fθ lens 34, the reflecting mirror 35, and the like.

The photosensitive drum 1 is irradiated with the laser light (FIG. 1) depending on the first information, through the reflecting mirror 35. Further, as shown in FIG. 2, a part of a scanning beam is detected by a photo-detector 36. The, depending on an output of the photo-detector 36, light emission start timing of the laser light L is controlled, so that a deviation of an image writing position with respect to a main scanning direction is suppressed. Here, the main scanning direction is a direction perpendicular to a rotational axis direction of the polygon mirror 33 and an optical axis direction of an optical lens system including the collimator lens 32 and the fθ lens 34.

The photo-detector 36 outputs a pulse signal proportional to the number of rotations (turns) of the scanner motor 30, so that a rotation state of the scanner motor 30 can be grasped by an internal of this pulse signal. A bearing of the scanner motor 30 is a dynamic pressure fluid bearing. As a liquid, oil is used (oil bearing). A viscosity of the oil used for oil bearing has temperature dependence. The oil is filled in a gap between a motor shaft and a bearing blanket, so that the motor shaft and the bearing blanket are in non-contact with each other during rotation.

Here, an image forming operation will be described. When the image forming operation is started (when a print instruction is received), first, the photosensitive drum 1 rotationally driven in an arrow Rd direction by a driving portion is electrically charged uniformly to a predetermined polarity and a predetermined potential. The photosensitive drum 1 after a surface thereof is charged is scanned with the laser light L depending on the image information by the scanning portion (exposure device) 3, with the result that electric charges of an exposed portion are removed, so that an electrostatic latent image is formed.

Then, this electrostatic latent image is developed by the developing device, so that a toner image is formed on the photosensitive drum 1. Incidentally, the developing device 4 includes the developing roller 4a, and a developing bias is applied to the developing roller 4a, so that toner is deposited on the electrostatic latent image on the photosensitive drum 1. As a result, the toner image is formed on the photosensitive drum 1.

On the other hand, in parallel to such a toner image forming operation, the recording material P accommodated in the sheet feeding cassette 7 is fed and controlled. The recording material P accommodated in the sheet feeding cassette 7 is fed and conveyed by the feeding portion 15 and the feeding roller pair 8 and passes through the top sensor 9, and thereafter, is fed to a transfer nip between the photosensitive drum 1 and the transfer roller 5. Incidentally, a leading end of the recording material P is detected by the top sensor 9, so that the leading end of the recording material P is synchronized with the toner image on the photosensitive drum 1. As a result, when the recording material P is fed to the transfer nip, by a transfer bias applied to the transfer roller 5, the toner image is transferred from the photosensitive drum 1 onto a predetermined position of the recording material P.

Then, the recording material P on which an unfixed toner image is carried is fed along the feeding guide 10 to a fixing nip in the fixing portion 11, so that the toner image is heat-fixed on the recording material P. Thereafter, the recording material P is fed by the feeding roller pair 12 and is discharged by the discharging roller pair 13 onto the discharge tray 14 provided at an upper surface of the apparatus main assembly M. On the other hand, the photosensitive drum 1 after the toner image transfer is cleaned by a cleaning blade 6a of the cleaning device 6 and prepares for subsequent image formation. By repeating the above-described operation, image formation can be successively carried out.

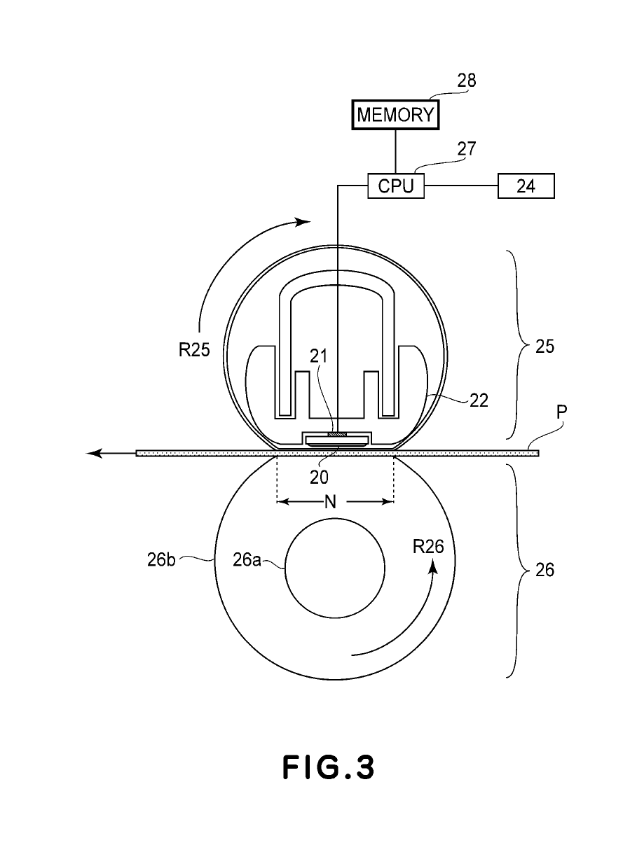

FIG. 3 is a schematic sectional view of the fixing device (fixing portion) 11. The fixing device 11 includes a heater (ceramic heater) 20 as a heating member for heating the toner image, a fixing film 25 accommodating the heater 20, and a pressing roller 26 as a member for forming the fixing nip between itself and the fixing film 25 in cooperation with the heater 20. The pressing roller 26 is driven by a fixing (device) motor 29 (FIG. 4) and is prepared by forming an elastic layer 26b of a silicone rubber or the like on an outer peripheral surface of a core metal 26a (FIG. 3).

The heater 20 is held by a heater holding member (heater holder) 22 provided in the apparatus main assembly M. The heater holder 22 is made of a heat-resistant resin material and has a semi-circular shape in cross-section. This heater holder 22 also has a function of guiding rotation of the fixing film 25.

The fixing film 25 is formed of a heat-resistant resin material such as polyimide in a cylindrical shape and rotates around the heater 20 and the heater holder 22 which are described above. The fixing film 25 is pressed against the heater 20 by the pressing roller 26, so that an inner peripheral surface of the fixing film 25 contacts a lower surface of the heater 20.

The fixing film 25 is rotated in an arrow R25 direction by rotation of the pressing roller 26 in an arrow R26 direction. Incidentally, at both end surfaces of the fixing film 25 with respect to a longitudinal direction (a direction perpendicular to the drawing sheet of FIG. 3), flange portions (unshown) provided on the heater holder 22 oppose each other, and by these flange portions, movement of the fixing film 25 in the longitudinal direction is prevented.

Here, on a back surface of the heater 20 a temperature detecting element (thermistor) 21 as a temperature detecting portion for detecting a temperature of the heater 20 is provided. That is, the thermistor 21 contacts the back surface of the heater 20, and a CPU 27 (FIG. 3) controls a triac 24 on the basis of the temperature detected by the thermistor 21 and thus controls energization to the heater 20 so that a detection temperature of the thermistor 21 is maintained at a setting temperature. When the toner image is fixed on the recording material P, the CPU 27 sets the setting temperature at a target temperature (fixing temperature) suitable for fixing the toner image.

As described above, the fixing portion 11 heats the toner image on the recording material P by the heater 20 while nipping and feeding the recording material P through the nip N by rotation of the pressing roller 26 in the arrow R26 direction (FIG. 3). At this time, by controlling the rotation of the pressing roller 26, a feeding speed of the recording material P can be appropriately controlled.

The fixing portion 11 in this embodiment starts the energization to the heater 20 after receiving a print instruction. That is, the energization to the heater 20 is not carried out in a stand-by state in which the CPU 27 awaits the print instruction, and therefore in the stand-by state, electric power consumption is very small.

FIG. 4 is a block diagram showing a relationship among the sheet feeding portion 15, the scanning portion 3 and the fixing portion 11 with the CPU as a central unit in the image forming apparatus of this embodiment. In FIG. 4, thick solid arrows represent information transmission systems of temperature information of the fixing portion 11 and rotation number information of the scanner motor toward the CPU 27 and an instruction transmission system from the CPU 27 to the solenoid 17 of the sheet feeding portion 15. These transmission systems are a principal part of this embodiment. Thin solid lines in FIG. 4 represent drive transmission in the scanning portion 3, the fixing portion 11 and the sheet feeding portion 15, and broken arrows represent instruction transmission systems between the CPU 27 and each of the respective portions 3, 11 and 15.

### (Sheet Feeding and Conveying Sequence)

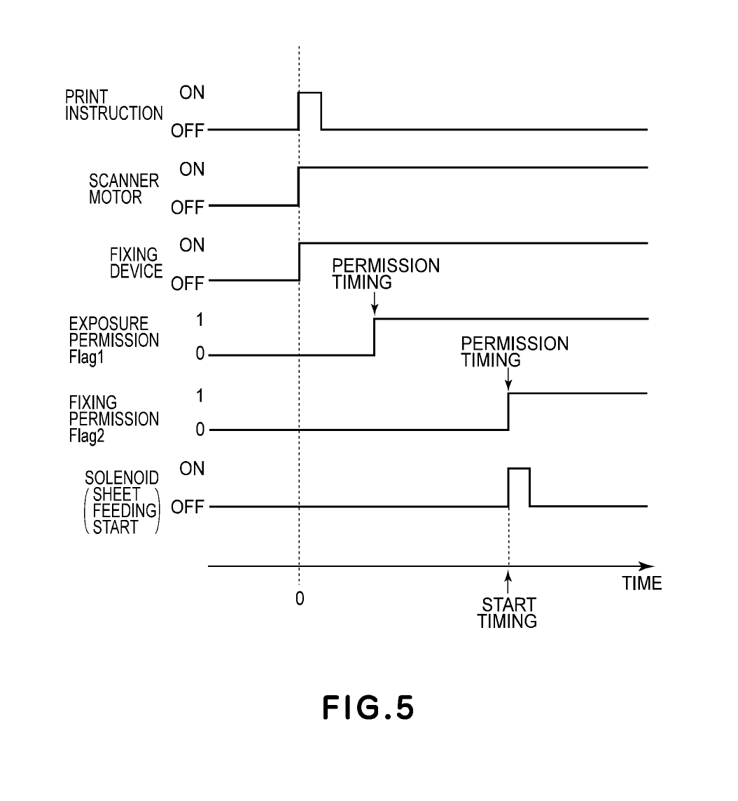

The image forming apparatus of this embodiment operates as shown in a time chart of FIG. 5 and determines feeding start timing of the recording material P. That is, drive of the scanner motor is started when a print instruction is received, and at the same time, temperature control (supply of electric power to the heater 20) is started so that the temperature of the fixing portion 11 rises to a fixable temperature. Thereafter, timing when the scanning portion (exposure device) 3 is in a sheet feeding permission state (i.e., exposure permission timing, timing when Flag 1 is 1) and timing when the fixing device (fixing portion) 11 is in a sheet feeding permission state (i.e., fixing permission timing, timing when Flag 2 is 1) are monitored.

Then, the CPU 27 as a controller for controlling sheet feeding start timing of the recording material P after receiving the print instruction determines, as the sheet feeding start timing, timing when both Flag 1 and Flag 2 are 1, and causes the solenoid 17 to start drive thereof. As shown in the time chart of FIG. 5, in the case of the image forming apparatus of this embodiment, a time required for preparing the fixing portion 11 is always longer than a time required for preparing the scanning portion 3, so that the sheet feeding start timing is equal to the fixing permission timing.

Here, a time obtained by adding a recording material feeding (conveying) time to a time from receipt of the print instruction to arrival at the sheet feeding start timing is the FPOT. The recording material feeding time is uniquely determined (for example, 3.4 sec) depending on a length of the recording material with respect to the feeding direction, a length of a sheet feeding path of the image forming apparatus or a process speed. For that reason, in order to further shorten the FPOT, there is a need to shorten the time from receipt of the print instruction to arrival at the sheet feeding start timing

### (Exposure Permission Timing)

In the following, the exposure permission timing of the scanning portion (exposure device) 3 (sheet feeding start permission timing at the exposure portion 3) in this embodiment will be described. The exposure permission timing in this embodiment is timing when after a start of energization to the scanner motor 30, the number of rotations is 98.3% or more of a target number of rotations (100%) when scanning depending on image information is carried out.

In the case where a periphery of the device is in a low-temperature environment, viscosity of oil becomes high, so that a rising speed of the scanner motor 30 is slower than that a normal-temperature environment. On the other hand, in the case of a high-temperature environment, the oil viscosity becomes low, so that the rising speed of the scanner motor 30 is faster than that in the normal temperature environment. The time from the receipt of the print instruction to the arrival at the exposure permission timing in this embodiment is somewhat different by a difference among individuals of the scanner motor 30, but in the case where the periphery of the device is in the normal-temperature environment (23° C.), the time is about 0.5 sec.

### (Fixing Permission Timing)

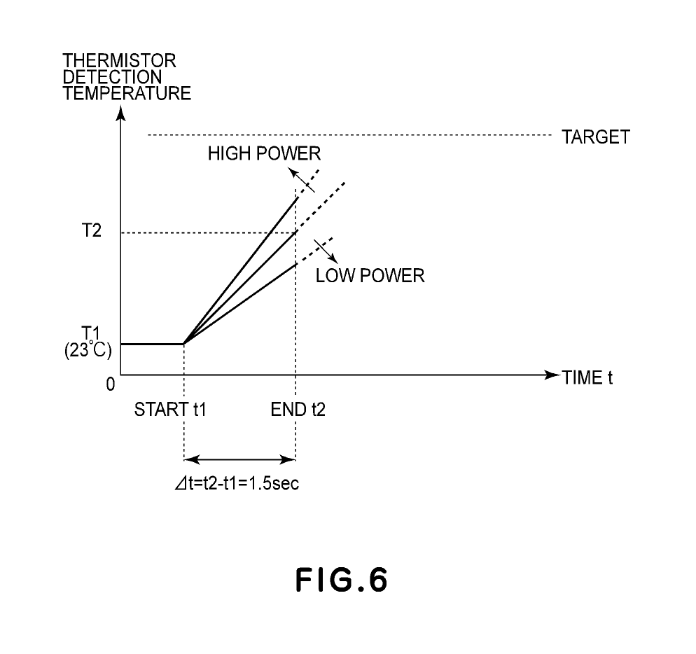

Next, the fixing permission timing (sheet feeding start permission timing at the fixing portion) of the fixing device (fixing portion) 11 in this embodiment will be described. FIG. 6 is a result of monitoring of detection temperature (temperature rise change) of the thermistor 21 contacting the back surface of the heater 20 in the case where the energization is started from a state in which the temperature of the heater 20 is equivalent to an environment temperature (23° C. in the normal temperature environment in this embodiment).

The electric power supplied to the fixing device is different depending on a fluctuation of a voltage of a commercial voltage source supplied to the image forming apparatus, so that a temperature rising speed of the heater 20 is faster with a higher supplied power and is a slower with a lower supplied power. That is, with the higher supplied power, even when a time from a start of the energization to a start of the feeding of the recording material is shortened, a sufficient fixing property can be ensured when the recording material reaches the nip N.

Referring to FIG. 6, in this embodiment, a detection temperature (thermistor detection temperature at the time of a start of measurement in FIG. 6) of the thermistor 21 when the energization to the heater 20 is started (t=t1 (sec)) is T1 (° C.). A detection temperature (thermistor detection temperature at the time of an end of measurement in FIG. 6) of the thermistor 21 after a lapse of 1.5 sec (t=t2 (sec)) is T2 (° C.).

Here, the CPU 27 (FIG. 3) functioning as a measuring portion for measuring a temperature rising rate of the detection temperature calculates (measures) a temperature rising rate ΔT (° C/sec)=(T2−T1)/(t2−t1). In this case, Δt=(t2−t1)=1.5 (sec) is a temperature rising rate measurement time (predetermined time required for measuring the temperature rising rate). It is assumed that the supplied (electric) power (voltage of the commercial voltage source) is higher with a larger temperature rising rate Δt (° C./sec), and it is assumed that the supplied power (voltage of the commercial voltage source) is lower with a smaller temperature rising rate ΔT (° C./sec).

Further, a difference in temperature of the heater 20 due to a difference in supplied power is smaller and thus it becomes difficult to detect the difference in temperature rising rate, and therefore, in order to estimate the supplied power with accuracy, there is a need that the temperature rising rate measurement time Δt is a predetermined time or more. For that reason, in this embodiment, in order to estimate the supplied power with accuracy, the temperature rising rate measurement time Δt is required to be at least 1.5 (sec). In this embodiment, the temperature rising rate measurement time Δt is fixed at 1.5 (sec). As shown in FIG. 6, the temperature rising rate measurement time (predetermined time) Δt is also an elapsed time from a start of the supply of the power to the heater 20 in response to the print instruction.

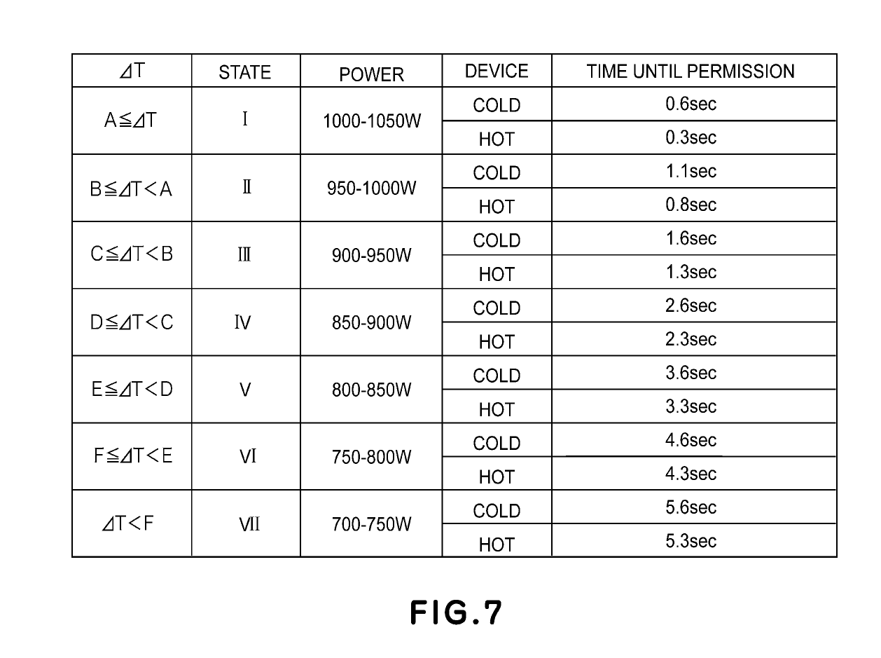

As described above, the image forming apparatus of this embodiment is capable of making the fixing permission timing earlier with a larger temperature rising rate ΔT. FIG. 7 is a correspondence table among the temperature rising rate ΔT, a time unit timing of the fixing device reaches the fixing permission timing, and the like. Values in the table are those in the case where the periphery of the device is in the normal-temperature environment (23° C.).

A hot/cold state of the fixing device is selected depending on the thermistor detection temperature (T1 (° C.) at the time of the start of measurement in FIG. 6) when the energization to the heater 20 is started. The cold state of the fixing device refers to a state of T1≤50° C., and the hot state of the fixing device refers to a state of T1>50° C.

Thus, for example, in the case where C≤ΔT≤B holds as a result of measurement of the temperature rising rate ΔT, a power state is estimated as a power state III, and as a time from receipt of a print instruction corresponding to the power state III until the timing of the fixing device reaches the fixing permission timing, 1.6 (sec) is determined. Such a mechanism is employed. Incidentally, the power state III corresponds to 900-950 W as an estimated supplied power. In FIG. 7, A to F which are thresholds of the respective power states and the times until the timing of the fixing device reaches the fixing permission timing in the respective power states are appropriately selected depending on an initial state of the fixing device, a printing mode, an environment temperature and the like.

### (Flowchart)

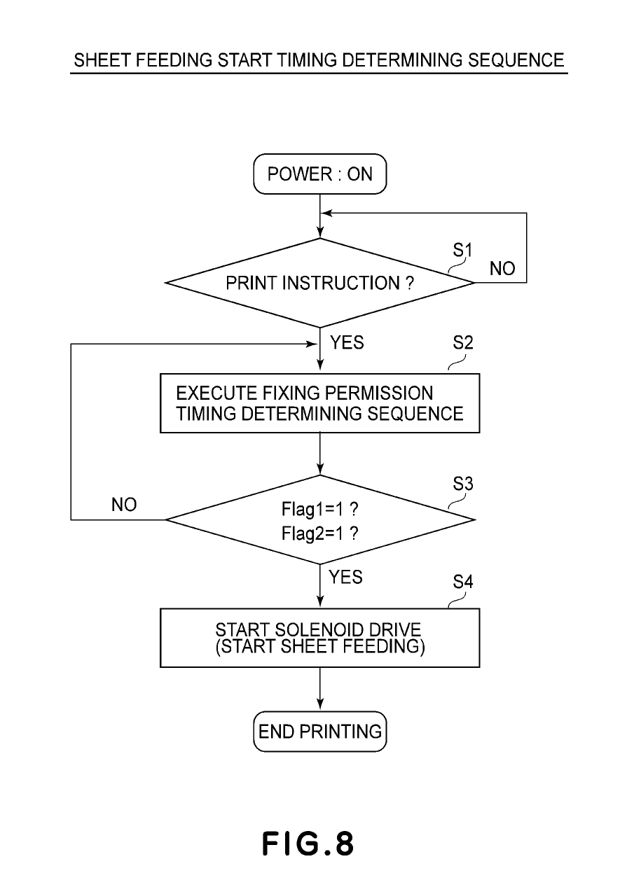

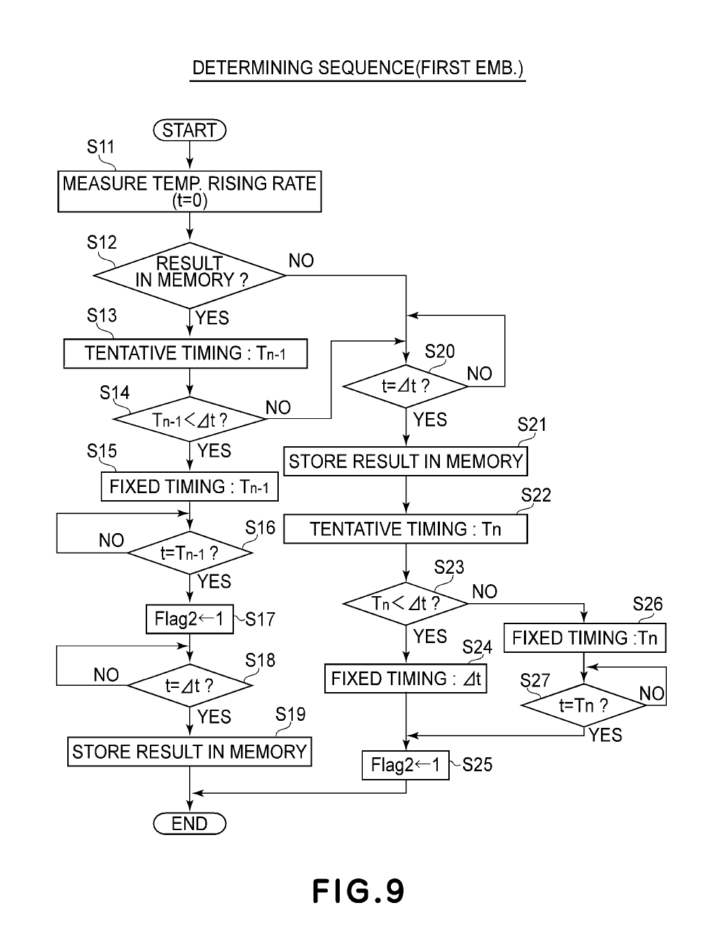

The image forming apparatus of this embodiment operates as shown in a flowchart of FIG. 8 and determines the sheet feeding start timing (timing when both Flag 1 and Flag 2 are 1). For that purpose, the image forming apparatus operates as shown in a flowchart of FIG. 9 and determines fixing permission timing (timing when both Flag 1 and Flag 2 are 1).

First, the sheet feeding start timing determination sequence will be described using FIG. 8. The CPU 27 discriminates whether or not the print instruction is provided (S1), and when the print instruction is provided, a fixing permission timing determination sequence is carried out (S2). Thereafter, at timing when both Flag 1 and Flag 2 are 1 (S3), drive of the solenoid is started (i.e., sheet feeding is started) (S4).

Then, the fixing permission timing determination sequence carried out in S2 of the flowchart of FIG. 8 will be described using FIG. 9. Energization to the heater 20 is started (t=t0), and at the same toner, measurement of a temperature rising rate for an N-th print instruction is started (S11). The CPU 27 discriminates whether or not a measurement result (information (value) relating to the temperature rising rate) of the temperature rising rate is stored in the memory 28 (FIG. 3) as a storing portion (S12), and in the case where the measurement result is stored in the memory 28, the CPU 27 tentatively determines the fixing permission timing as Tₙ₋₁ from the measurement result for an (N-1)-th print instruction (S13).

The tentatively determined fixing permission timing Tₙ₋₁ and the temperature rising rate measurement time ΔT (=1.5 (sec), fixed) are compared with each other, and with Tₙ₋₁<Δt as a condition (S14), the fixing permission timing is determined (fixed) at Tₙ₋₁ (S15). Thereafter, when the timing reaches the fixing permission timing (t=Tₙ₋₁) (S16), Flag 2 is set at 1 (S17). Further, when the temperature rising rate measurement time elapses (t=Δt) (S18), the CPU 27 as the controller causes the memory 28 (FIG. 3) to store the measurement result of the temperature rising rate for the N-th print instruction (S19).

On the other hand, returning to S12 of FIG. 9, in the case where the measurement result is not stored in the memory 28 (FIG. 3), when the temperature rising rate measurement time elapses (t=Δt) (S20), the CPU 27 causes the storing portion to store the measurement result for the N-th print instruction (S21). Then, the CPU 27 tentatively determines, as Tₙ, the fixing permission timing for the N-th print instruction based on the measurement result for the N-th print instruction (S22).

Similarly, returning to S14 of FIG. 9, in the case where Tₙ₋₁ is not smaller than Δt (Tₙ₋₁>Δt), when the temperature rising rate measurement time elapses (t=Δt) (S20), the CPU 27 causes the storing portion to store the measurement result for the N-th print instruction (S21). Then, the CPU 27 tentatively determines, as Tₙ, the fixing permission timing for the N-th print instruction based on the measurement result for the N-th print instruction (S22).

Then, in a situation such that the temperature rising rate measurement time Δt elapses, the tentatively determined fixing permission timing Tₙ and the temperature rising rate measurement time Δt are compared with each other, with Tₙ<Δt as a condition (S23), the fixing permission timing is determined at Tₙ (S24). Thereafter, Flag 2 is set at 1 (S25). On the other hand, returning to S23, with Δt≤Tₙ as a condition, the fixing permission timing is determined at Tₙ (S26). Thereafter, when the timing reaches the fixing permission timing (t=Tₙ), Flag 2 is set at 1 (S25). The fixing permission timing in the step S26 is timing when the temperature (detection temperature of the thermistor 21) of the fixing device 11 reaches the above-described fixing temperature or a predetermined temperature lower than the fixing temperature.

(Functional Effect of this Embodiment)

As described above, in a high power state in which the temperature rising rate ΔT is large, the image forming apparatus is in a state in which a time from receipt of the print instruction until the timing of the fixing device reaches the fixing permission timing can be shortened. However, in the case where the sheet feeding start timing for the N-th print instruction is determined on the basis of the measurement result of the temperature rising rate for the N-th print instruction, the sheet feeding start timing for the N-th print instruction cannot be inevitably be made earlier than timing required for measurement of the temperature rising rate for the N-th print instruction. That is, although the image forming apparatus is in a state in which a time from receipt of the print instruction until the sheet is fed can be made shorter than the temperature rising rate measurement time of 1.5 (sec).

In view of this, in this embodiment, in the case where a predetermined condition is satisfied, the sheet feeding start timing for the N-th print instruction is set at sheet feeding start timing for the (N-1)-th print instruction based on the temperature rising rate for the (N-1)-th print instruction stored in the storing portion. The case where the predetermined condition is satisfied is the case where the sheet feeding start timing for the (N-1)-th print instruction based on the measurement result of the temperature rising rate for the (N-1)-th print instruction stored in the storing portion is earlier than end timing of a predetermined time required for measuring the temperature rising rate. The case where a voltage state of the commercial voltage source, an environment temperature at a periphery of the image forming apparatus and the like largely fluctuate in a short time is a few cases. In consideration of this tendency, in this embodiment, when the sheet feeding start timing for the N-th print instruction is determined, reference to information on the temperature rising rate for the (N-1)-th print instruction is made.

Thus, the image forming apparatus of this embodiment executes the time chart of FIG. 5 and the flowcharts of FIGS. 8 and 9. As a result, the sheet feeding start timing after the image forming apparatus receives the N-th print instruction can be made earlier than the end timing of the measurement for the N-th print instruction. That is, the sheet feeding start timing for the N-th print instruction can be made earlier (timewisely) than timing from after the receipt of the print instruction until the time reaches the temperature rising rate measurement time, so that the FPOT can be further shortened.

(Experiment in Which this Embodiment is Compared with Comparison Example 1)

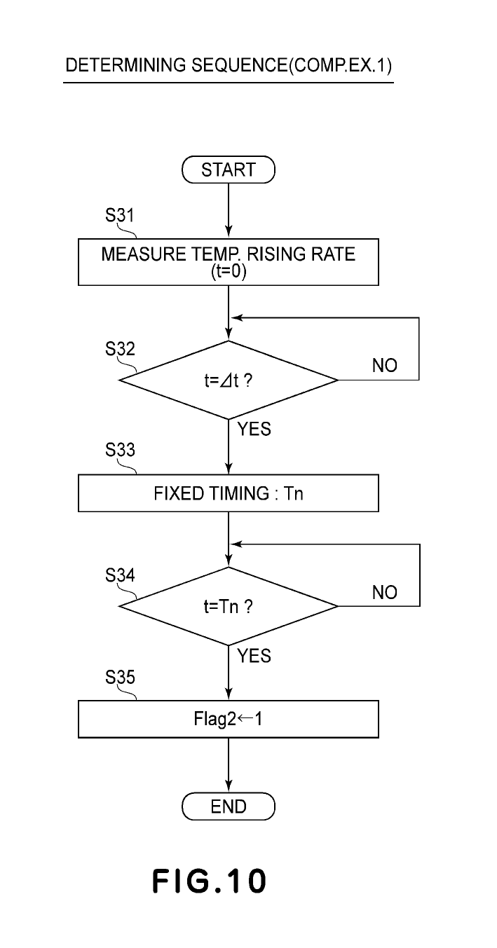

An experiment in which this embodiment is compared with Comparison Example 1 will be described. Basic constitution and operation of an image forming apparatus of Comparison Example 1 are substantially the same as those of the image forming apparatus of this embodiment, but the image forming apparatus of Comparison Example 1 is capable of executing a flowchart of FIG. 10 different from the flowchart of FIG. 9 used in this embodiment (First Embodiment). First, measurement of the temperature rising rate for the N-th print instruction is started simultaneously with energization a start (t=0) of energization to the heater (S31). When the temperature rising rate measurement time elapses (t=Δt) (S32), the fixing permission timing is determined at Tₙ from a temperature rising rate measurement result for the N-th print instruction (S33).

Thereafter, when the timing reaches the fixing permission timing (t=Tₙ) (S34), Flag 2 is set at 1 (S35).

### 1) Experimental Condition

Environmental temperature: normal temperature (23° C.)
Process speed: 220 mm/sec
Printing mode: plain paper
Paper kind: LTR size (paper length: 297 mm), Vitality (manufactured by Xerox Corp., basis weight: 75 g/m²)

Feeding method: Printing of 6 sheets with 10 min-intermittent feeding per sheet in which supplied (electric) power is changed to 850 W, 950 W and 1050 W for each 2 sheets.

### 2) Experimental Result

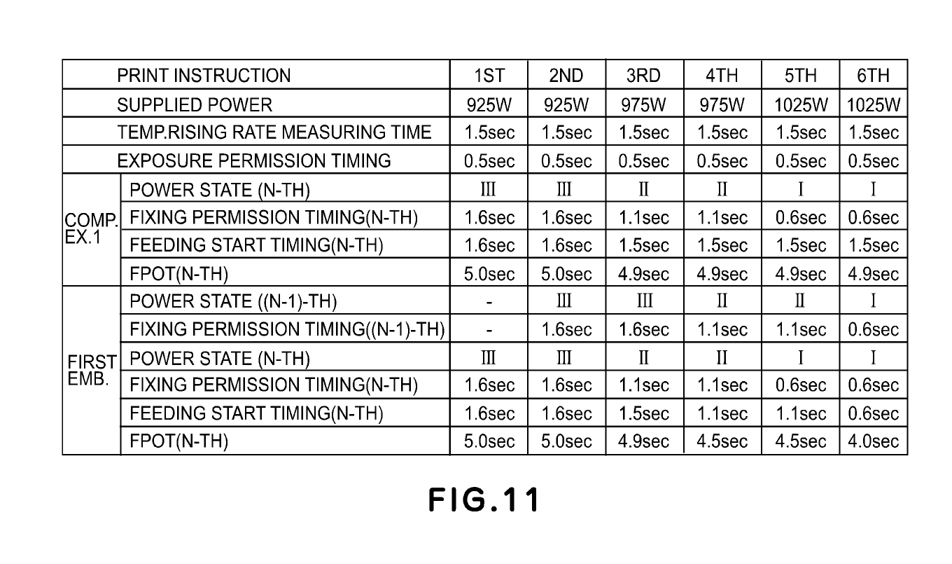

An experimental result is summarized in FIG. 11. In Comparison Example 1 in which the fixing permission timing for N-th print instruction is determined on the basis of the temperature rising rate measurement result for the N-th print instruction, sheet feeding timing for first print instruction is 1.6 (sec). Then, those for second print instruction and later print instructions are 1.6 (sec), 1.5 (sec), 1.5 (sec), 1.5 (sec) and 1.5 (sec) in tern. Further, the FPOT for the first print instruction is 5.0 (sec), and those for the second print instruction and later print instructions are 5.0 (sec), 4.9 (sec), 4.9 (sec), 4.9 (sec) and 4.9 (sec) in tern.

On the other hand, in this embodiment (first Embodiment, sheet feeding timing for first print instruction is 1.6 (sec), and those for second print instruction and later print instructions are 1.6 (sec), 1.5 (sec), 1.1 (sec), 1.1 (sec) and 0.6 (sec) in tern. Further, the FPOT for the first print instruction is 5.0 (sec), and those for the second print instruction and later print instructions are 5.0 (sec), 4.9 (sec), 4.5 (sec), 4.5 (sec) and 4.0 (sec) in tern.

Thus, when Comparison Example 1 and First Embodiment were compared with each other, in First Embodiment, the FPOT was able to be shortened by 0.9 (sec) at maximum compared with Comparison Example 1.

(Summarization of this Embodiment)

As described above, in this embodiment, the case where there is no large fluctuation in power source voltage supplied to the image forming apparatus is assumed, and in a predetermined condition, the sheet feeding start timing for the N-th print instruction is set at sheet feeding start timing determined from the temperature rising rate measurement result for the (N-1)-th print instruction. As a result, the FPOT can be further shortened.

### <Second Embodiment>

An image forming apparatus of Second Embodiment has substantially the same constitution and operation as those in First Embodiment. This embodiment is characterized in that a control temperature at which the recording material at the fixing portion is heat-controlled is increased in the case where a measurement result for the N-th print instruction stored in the storing portion is lowered from a measurement result for the (N-1)-th print instruction stored in the storing portion by more than a first thermistor.

There is a case that a difference generates between a temperature rising rate measurement result for the (N-1)-th print instruction (last power state) and a temperature rising rate measurement result for the N-th print instruction (current power state) in the image forming apparatus of First Embodiment. This is because as described above, the power supplied to the image forming apparatus is different depending on the voltage of the commercial voltage source. An ideal voltage source (power source) is capable of outputting a certain voltage irrespective of a use status of another electronic device, but a general-purpose commercial voltage source fluctuates not a little.

Accordingly, the case where although the power state is presumed as a high power state from the temperature rising rate measurement result for the (N-1)-th print instruction, the voltage of the commercial voltage source lowers until the N-th print instruction and thus the power state changes to a low power state at the N-th print instruction would be considered. In this case, the sheet is fed at short sheet feeding start timing for the (N-1)-th print instruction in the high power state although an actual power state is the low power state and therefore, a possibility that improper fixing occurs would be considered.

Therefore, in this embodiment, the image forming apparatus capable of suppressing the improper fixing which can occur in the case where the temperature rising rate measurement result for the (N-1)-th print instruction and the temperature rising rate measurement result for the N-th print instruction are different from each other is provided.

### (Sheet Feeding Sequence)

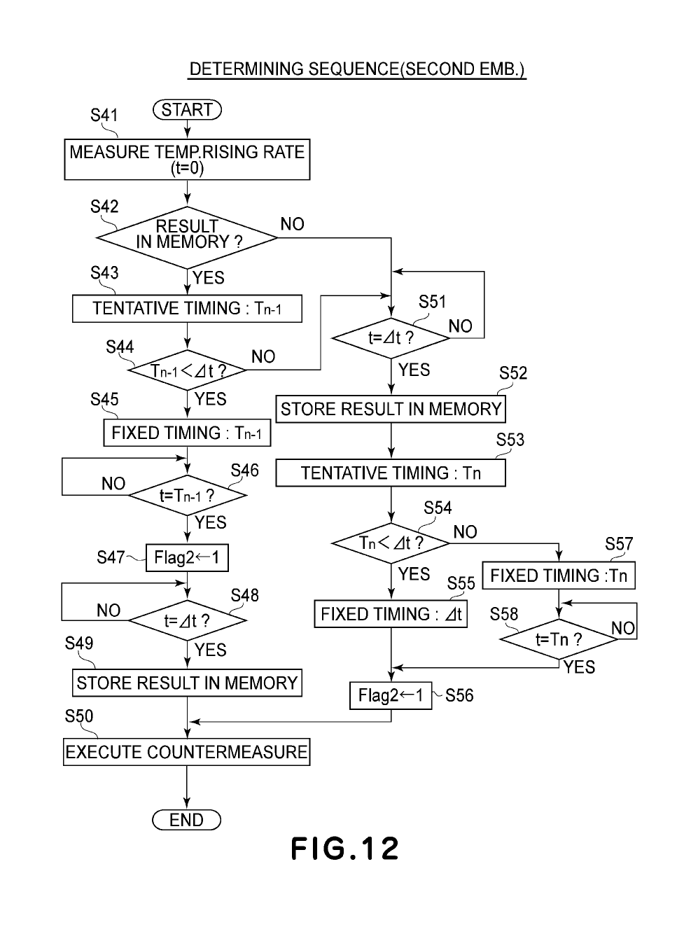

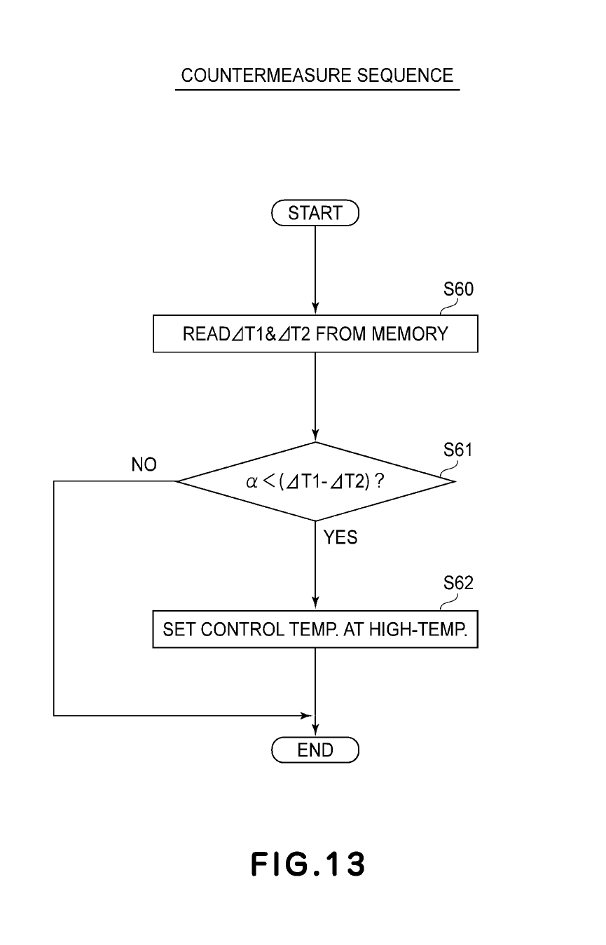

In view of the above-described circumstances, the image forming apparatus of this embodiment operates as shown in a flowchart of FIG. 8 and determines the sheet feeding start timing (timing when both Flag 1 and Flag 2 are 1) similarly as in First Embodiment. Further, the image forming apparatus operates as shown in flowcharts of FIGS. 12 and 13 and determines fixing permission timing (timing when both Flag 1 and Flag 2 are 1).

First, the sheet feeding start timing determination sequence determination sequence will be described. The sheet feeding start timing determination sequence is performed according to the flowchart of FIG. 8, so that the sheet feeding start timing is determined. The CPU 27 discriminates whether or not the print instruction is provided (S1), and when the print instruction is provided, a fixing permission timing determination sequence is carried out (S2). Thereafter, at timing when both Flag 1 and Flag 2 are 1 (S3), drive of the solenoid is started (i.e., sheet feeding is started) (S4).

Then, the fixing permission timing determination sequence carried out in S2 of the flowchart of FIG. 8 will be described. The fixing permission timing determination sequence is performed according to a flowchart of FIG. 12, so that the fixing permission timing is determined. Energization to the heater 20 is started (t=t0), and at the same toner, measurement of a temperature rising rate for an N-th print instruction is started (S41). The CPU 27 discriminates whether or not a measurement result is stored in the memory 28 (FIG. 3) as a storing portion (S42), and in the case where the measurement result is stored in the memory 28, the CPU 27 tentatively determines the fixing permission timing as Tₙ₋₁ from the measurement result for an (N-1)-th print instruction (S43).

Then, the tentatively determined fixing permission timing Tₙ₋₁ and the temperature rising rate measurement time ΔT (=1.5 (sec)) are compared with each other, and with Tₙ₋₁<Δt as a condition (S44), the fixing permission timing is determined at Tₙ₋₁ (S45). Thereafter, when the timing reaches the fixing permission timing (t=Tₙ₋₁) (S46), Flag 2 is set at 1 (S47). Further, when the temperature rising rate measurement time elapses (t=Δt) (S48), the CPU 27 causes the storing portion to store the measurement result for the N-th print instruction (S49). That is, the CPU 27 causes the storing portion to store the measurement result for the N-th print instruction simultaneously with or after an end of a predetermined time set for the N-th print instruction.

Then, a voltage fluctuation countermeasure sequence shown in FIG. 13 described later is carried out (S50).

On the other hand, returning to S42, in the case where the measurement result is not stored in the storing portion, when the temperature rising rate measurement time elapses (t=Δt) (S51), the CPU 27 causes the storing portion to store the measurement result for the N-th print instruction (S52), and tentatively determines, as Tₙ, the fixing permission timing for the N-th print instruction based on the measurement result for the N-th print instruction (S53).

Similarly, returning to S14 of FIG. 9, in the case where Tₙ₋₁ is not smaller than Δt, when the temperature rising rate measurement time elapses (t=Δt) (S51), the CPU 27 causes the storing portion to store the measurement result for the N-th print instruction (S52). That is, the CPU 27 causes the storing portion to store the measurement result for the N-th print instruction simultaneously with or after an end of a predetermined time set for the N-th print instruction. Then, the CPU 27 tentatively determines, as Tₙ, the fixing permission timing for the N-th print instruction based on the measurement result for the N-th print instruction (S53).

The tentatively determined fixing permission timing Tₙ and the temperature rising rate measurement time Δt are compared with each other, with Tₙ<Δt as a condition (S54), the fixing permission timing is determined at Tₙ (S55). Thereafter, Flag 2 is set at 1 (S56), and the voltage fluctuation countermeasure sequence is carried out (S50).

On the other hand, returning to S54, with Δt≤Tₙ as a condition, the fixing permission timing is determined at Tₙ (S57). Thereafter, when the timing reaches the fixing permission timing (t=Tₙ), (S58), Flag 2 is set at 1 (S56), and the voltage fluctuation countermeasure sequence is carried out (S50).

Further, the voltage fluctuation countermeasure sequence carried out in S50 of the flowchart of FIG. 12 will be described. The voltage fluctuation countermeasure sequence is performed according to a flowchart of FIG. 13. The CPU 27 reads, from the storing portion, a temperature rising rate measurement result ΔT1 for the N-th print instruction and a temperature rising rate measurement result ΔT2 for the (N-1)-th print instruction (S60). Then, the CPU 27 calculates (ΔT1-ΔT2), and with a condition such that (ΔT1-ΔT2) exceeds a (certain) first threshold (threshold a) (S61), the CPU 27 sets a control temperature (fixing temperature) during passing of the recording material through the fixing device, at a temperature on a high-temperature side (S62).

Accordingly, the image forming apparatus of this embodiment feeds the sheet at sheet feeding start timing for the N-th print instruction as sheet feeding start timing determined from the temperature rising rate measurement result for the (N-1)-th print instruction. Thereafter, with a condition such that a difference between the temperature rising rate measurement result for the N-th print instruction and the temperature rising rate measurement result for the (N-1)-th print instruction exceeds the first threshold, the control temperature during the passing of the recording material through the fixing device is changed. This is a feature of this embodiment.

(Functional Effect of this Embodiment)

The functional effect of this embodiment is similar to that of First Embodiment in principle, and therefore will be omitted from description. However, in this embodiment, even when the power state is changed to the low power state due to a lowering in voltage of the commercial voltage source until the N-th print instruction although the power state is presumed as the high power state from the temperature rising rate measurement result for the (N-1)-th print instruction, occurrence of improper fixing can be suppressed.

(Summarization of this Embodiment)

The image forming apparatus of this embodiment is capable of shortening the FPOT while suppressing the occurrence of the improper fixing even when the power state is changed to the low power state due to the lowering in voltage of the commercial voltage source until the N-th print instruction although the power state is presumed as the high power state from the temperature rising rate measurement result for the (N-1)-th print instruction.

### <Third Embodiment>

An image forming apparatus of Third Embodiment has substantially the same constitution and operation as those in Second Embodiment. This embodiment is characterized in that sheet feeding start timing for the N-th print instruction is changed depending on whether or not an elapsed time from the (N-1)-th print instruction to the N-th print instruction is shorter than a second threshold (threshold β).

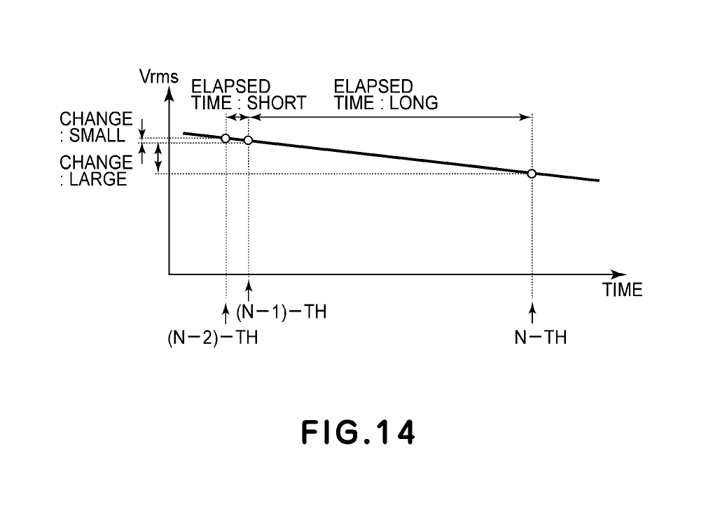

There is a possibility that a difference between a temperature rising rate measurement result for the (N-1)-th print instruction (last power state) and a temperature rising rate measurement result for the N-th print instruction (current power state) becomes larger with a longer elapsed time from the (N-1)-th print instruction to the N-th print instruction (FIG. 14). For that reason, with a longer elapsed time, the sheet is fed at short sheet feeding start timing in the high power state although the power state is changed to the lower power state and therefore, there was a possibility that improper fixing occurs.

Therefore, in this embodiment, the image forming apparatus capable of suppressing the improper fixing which can occur in the case where the elapsed time from the (N-1)-th print instruction to the N-th print instruction becomes long (i.e., in the case where the power source voltage fluctuates at a medium or long period) is provided.

### (Sheet Feeding Sequence)

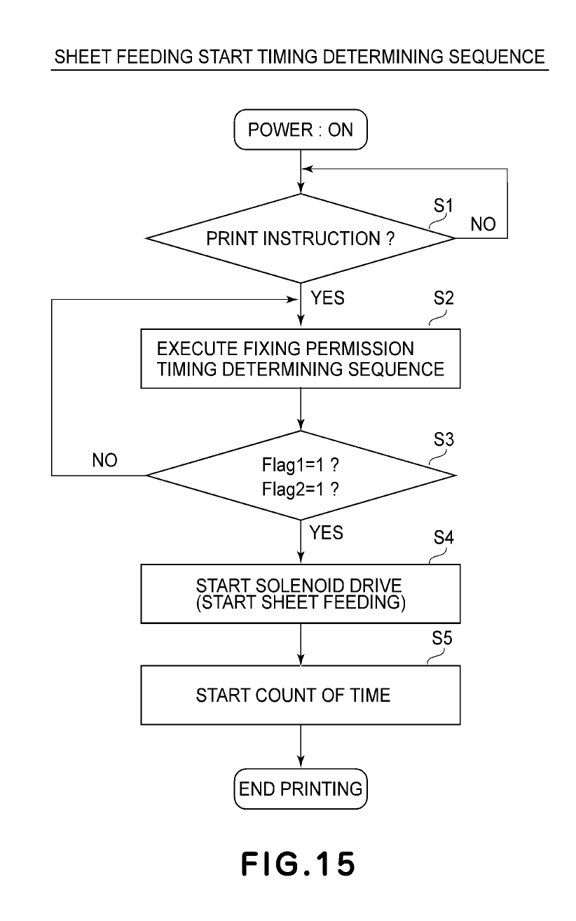

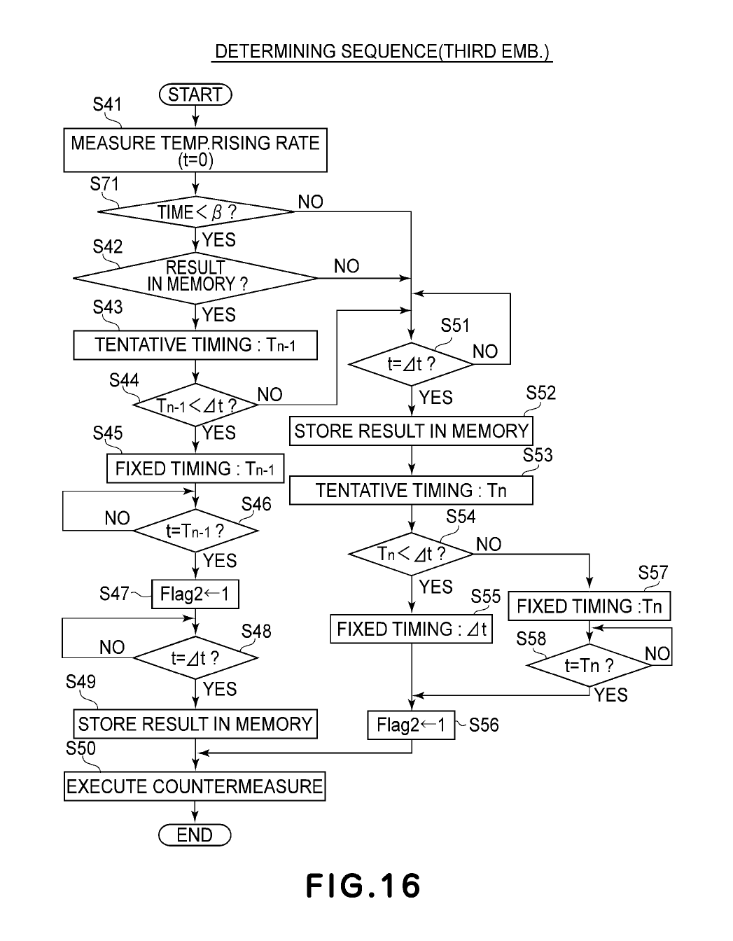

In view of the above-described circumstances, the image forming apparatus of this embodiment operates as shown in a flowchart of FIG. 15 and determines the sheet feeding start timing (timing when both Flag 1 and Flag 2 are 1). Further, the image forming apparatus operates as shown in flowcharts of FIGS. 13 and 16 and determines fixing permission timing (timing when both Flag 1 and Flag 2 are 1).

First, the sheet feeding start timing determination sequence is determined with reference to the flowchart of FIG. 15. The CPU 27 discriminates whether or not the print instruction is provided (S1), and when the print instruction is provided, a fixing permission timing determination sequence is carried out (S2). Thereafter, at timing when both Flag 1 and Flag 2 are 1 (S3), drive of the solenoid is started (i.e., sheet feeding is started) (S4). Further, time count is started (S5).

Then, the fixing permission timing is determined with reference to a flowchart of FIG. 16. Energization to the heater 20 is started (t=t0), and at the same toner, measurement of a temperature rising rate for an N-th print instruction is started (S41). The CPU 27 discriminates whether or not the time count of the elapsed time from the (N-1)-th print instruction to the N-th print instruction exceeds the threshold β (S71), and when the time count is smaller than the threshold β, the CPU 27 discriminates whether or not the measurement result is stored in the storing portion (S42).

Further, in the case where the measurement result is stored in the storing portion, the CPU 27 tentatively determines the fixing permission timing as Tₙ₋₁ from the measurement result for an (N-1)-th print instruction (S43). Then, the tentatively determined fixing permission timing Tₙ₋₁ and the temperature rising rate measurement time ΔT are compared with each other, and with Tₙ₋₁<Δt as a condition (S44), the fixing permission timing is determined at Tₙ₋₁ (S45). Thereafter, when the timing reaches the fixing permission timing (t=Tₙ₋₁) (S46), Flag 2 is set at 1 (S47). Further, when the temperature rising rate measurement time elapses (t=Δt) (S48), the CPU 27 causes the storing portion to store the measurement result for the N-th print instruction (S49), and carries out the voltage fluctuation countermeasure sequence (S50).

On the other hand, returning to S44 of FIG. 16, in the case where Tₙ₋₁ is not smaller than Δt, when the temperature rising rate measurement time elapses (t=Δt) (S51), the CPU 27 causes the storing portion to store the measurement result for the N-th print instruction (S52). Then, the CPU 27 tentatively determines, as Tₙ, the fixing permission timing for the N-th print instruction based on the measurement result for the N-th print instruction (S53).

The tentatively determined fixing permission timing Tₙ and the temperature rising rate measurement time Δt are compared with each other, with Tₙ<Δt as a condition (S54), the fixing permission timing is determined at Tₙ (S55). Thereafter, Flag 2 is set at 1 (S56), and the voltage fluctuation countermeasure sequence is carried out (S50).

On the other hand, returning to S54, with Δt≤Tₙ as a condition, the fixing permission timing is determined at Tₙ (S57). Thereafter, when the timing reaches the fixing permission timing (t=Tₙ), (S58), Flag 2 is set at 1 (S56), and the voltage fluctuation countermeasure sequence is carried out (S50).

On the other hand, in the case where returning to S71, the time count is the threshold β or more or in the case where returning to S42, there is no measurement result, when the temperature rising rate measurement time elapses (t=Δt) (S51), the CPU 27 causes the storing portion to store the measurement result for the N-th print instruction (S52). Then, the CPU 27 tentatively determines the fixing permission timing at Tₙ from the measurement result for the N-th print instruction (S53). The tentatively determined fixing permission timing Tₙ and the temperature rising rate measurement time ΔT are compared with each other, with Tₙ-Δt as a condition (S54), the fixing permission timing is determined at Δt (S55). Thereafter, Flag 2 is set at 1 (S56), and the voltage fluctuation countermeasure sequence is carried out (S50).

On the other hand, returning to S54, with Δt≤Tₙ as a condition, the fixing permission timing is determined at Tₙ (S57). Thereafter, when timing reaches the fixing permission timing (t=Tₙ) (S58), Flag 2 is set at 1 (S56), and the voltage fluctuation countermeasure sequence is carried out (S50).

As described above, in this embodiment, in the case where the elapsed time from the last print instruction to the current print instruction exceeds a certain threshold when the sheet feeding timing for the current print instruction is determined, a constitution in which the sheet feeding timing determined from the measurement result after the last print instruction stored in the storing portion is not used is employed.

(Functional Effect of this Embodiment)

The functional effect of this embodiment is similar to those of First and Second Embodiments in principle, and therefore, will be omitted from description. However, compared with First and Second Embodiments, improper fixing which can occur in the case where the elapsed time from the (N-1)-th print instruction to the N-th print instruction becomes long (i.e., in the case where the power source voltage fluctuates at a medium or long period) can be suppressed.

(Summarization of this Embodiment)

As described above, in this embodiment, the FPOT can be shortened while enabling suppressing of the occurrence of the improper fixing which can occur in the case where the elapsed time from the (N-1)-th print instruction to the N-th print instruction becomes long, i.e., in the case where the power source voltage fluctuates at the medium or long period.

### <Fourth Embodiment>

An image forming apparatus of Fourth Embodiment has substantially the same constitution and operation as those in Third Embodiment. This embodiment is characterized in that sheet feeding start timing for the N-th print instruction is changed depending on whether or not a fluctuation range of the measurement result for the Nth print instruction relative to a plurality of measurement results for preceding print instructions including the (N-1)-th print instruction is smaller than a third threshold (threshold γ).

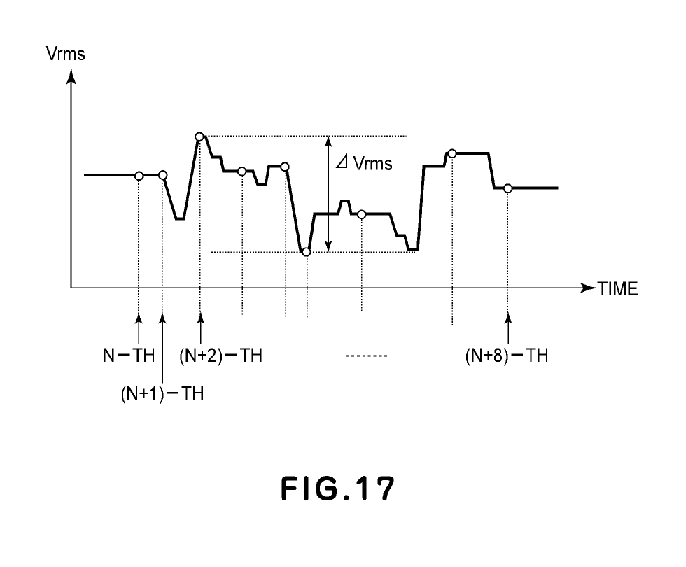

There was a possibility that the voltage of the commercial voltage source fluctuates at a short time period, and a difference between a temperature rising rate measurement result for the (N-1)-th print instruction (last power state) and a temperature rising rate measurement result for the N-th print instruction (current power state) becomes larger with a larger fluctuation range (FIG. 17). For that reason, the voltage of the commercial voltage source fluctuates at the short time period and with a larger elapsed time, the sheet is fed at short sheet feeding start timing in the high power state although the power state is changed to the lower power state and therefore, there was a possibility that improper fixing occurs.

Therefore, in this embodiment, the image forming apparatus capable of suppressing the improper fixing which can occur in the case where the power source voltage fluctuates at the short time period is provided.

### (Sheet Feeding Sequence)

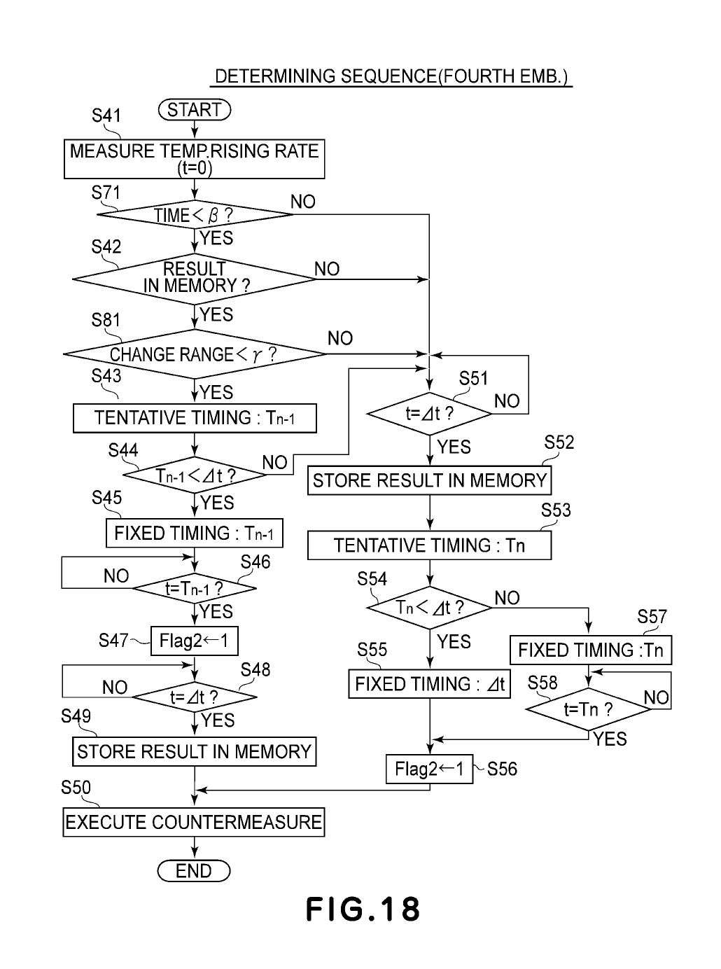

In view of the above-described circumstances, the image forming apparatus of this embodiment operates as shown in a flowchart of FIG. 15 and determines the sheet feeding start timing (timing when both Flag 1 and Flag 2 are 1). Further, the image forming apparatus operates as shown in flowcharts of FIGS. 15 and 18 and determines fixing permission timing (timing when both Flag 1 and Flag 2 are 1).

In this embodiment, the fixing permission timing is determined with reference to a flowchart of FIG. 18. Energization to the heater 20 is started (t=t0), and at the same toner, measurement of a temperature rising rate for an N-th print instruction is started (S41). Then, the CPU 27 discriminates whether or not the time count of the elapsed time from the (N-1)-th print instruction to the N-th print instruction exceeds the threshold β (S71).

When the time count is smaller than the threshold β, the CPU 27 discriminates whether or not the measurement result is stored in the storing portion (S42), and in the case where the measurement result is stored in the storing portion, the CPU 27 discriminates whether or not the fluctuation range of the several preceding temperature rising rate measurement results exceeds the threshold γ (S81). When the fluctuation range exceeds the threshold γ, the CPU 27 tentatively determines the fixing permission timing as Tₙ₋₁ from the measurement result for an (N-1)-th print instruction (S43). Then, the tentatively determined fixing permission timing Tₙ₋₁ and the temperature rising rate measurement time ΔT are compared with each other, and with Tₙ₋₁<Δt as a condition (S44), the fixing permission timing is determined at Tₙ₋₁ (S45). Thereafter, when the timing reaches the fixing permission timing (t=Tₙ₋₁) (S46), Flag 2 is set at 1 (S47). Further, when the temperature rising rate measurement time elapses (t=Δt) (S48), the CPU 27 causes the storing portion to store a currently measured temperature rising rate ΔTₙ (S49), and carries out the voltage fluctuation countermeasure sequence (S50).

On the other hand, returning to S44 of FIG. 18, in the case where T_{n—}1 is not smaller than Δt, when the temperature rising rate measurement time elapses (t=Δt) (S51), the CPU 27 causes the storing portion to store the measurement result for the N-th print instruction (S52). Then, the CPU 27 tentatively determines, as Tₙ, the fixing permission timing for the N-th print instruction based on the measurement result for the N-th print instruction (S53).

The tentatively determined fixing permission timing Tₙ and the temperature rising rate measurement time Δt are compared with each other, with Tₙ<Δt as a condition (S54), the fixing permission timing is determined at Tₙ (S55). Thereafter, Flag 2 is set at 1 (S56), and the voltage fluctuation countermeasure sequence is carried out (S50).

On the other hand, in the case where returning to S71 of FIG. 18, the time count is the threshold β or more or in the case where returning to S42, there is no measurement result or in the case where returning to S81, the fluctuation range of the preceding several temperature rising rate measurement results, the following operation is performed. That is, when the temperature rising rate measurement time elapses (t=Δt) (S51), the CPU 27 causes the storing portion to store the measurement result for the N-th print instruction (S52), and tentatively determines the fixing permission timing at Tₙ from the measurement result for the N-th print instruction (S53).

The tentatively determined fixing permission timing Tₙ and the temperature rising rate measurement time ΔT are compared with each other, with Tₙ-Δt as a condition (S54), the fixing permission timing is determined at Δt (S55). Thereafter, Flag 2 is set at 1 (S56), and the voltage fluctuation countermeasure sequence is carried out (S50). On the other hand, returning to S54, with Δt≤Tₙ as a condition, the fixing permission timing is determined at Tₙ (S57). Thereafter, when timing reaches the fixing permission timing (t=Tₙ) (S58), Flag 2 is set at 1 (S56), and the voltage fluctuation countermeasure sequence is carried out (S50).

(Functional Effect of this Embodiment)

The functional effect of this embodiment is similar to those of either one of First to Third Embodiments in principle, and therefore, will be omitted from description. However, compared with either one of First to Third Embodiments, improper fixing which can occur in the case where the voltage of the commercial voltage source used in the image forming apparatus fluctuates at the short time period can be suppressed.

(Summarization of this Embodiment)

As described above, in this embodiment, the FPOT can be shortened while suppressing the occurrence of the improper fixing which can occur in the case where the voltage of the commercial voltage source used in the image forming apparatus fluctuates at the short time period.

### (Modified Embodiments)

In the above preferred embodiments of the present invention were described, but the present invention is not limited thereto and can be variously modified or changed within the scope thereof. In the above-described embodiments, the thermistor 21 detects the temperature of the heater 20 but may also detect the temperature of the fixing film 25 or the temperature of the pressing roller 26.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-022967 filed on Feb. 13, 2018, which is hereby incorporated by reference herein in its entirety.

What is claimed is:

1. An image forming apparatus comprising:
an image forming portion configured to form a toner image on a recording material;
a fixing portion configured to fix the toner image on the recording material by heating the toner image formed on the recording material;
a temperature detecting portion configured to detect a temperature of said fixing portion;
a measuring portion configured to measure, with said temperature detecting portion, a temperature rising rate of said fixing portion when the temperature of said fixing portion rises, upon receipt of a print instruction, to a predetermined temperature at which the toner image is fixable;
a storing portion configured to store a value relating to the temperature rising rate measured by said measuring portion; and
a controller configured to control feeding start timing of the recording material,
wherein said controller is capable of setting a case that a start of feeding of the recording material is permitted after a lapse of a predetermined time need to measure the temperature rising rate and a case that the start of feeding of the recording material is permitted, depending on the value stored in said storing portion, at timing before the lapse of the predetermined time.

2. An image forming apparatus according to claim 1, wherein said value for an (N-1)-th print instruction is stored in said storing portion, and
wherein when said value for the (N-1)-th print instruction is smaller than a value relating to the predetermined time, said controller sets timing of permission of a start of feeding of the recording material for an N-th print instruction at timing before a lapse of the roller time and depending on said value stored in said storing portion.

3. An image forming apparatus according to claim 2, wherein when said value for the (N-1)-th print instruction stored in said storing portion is smaller than the value relating to the predetermined time, said controller sets th timing of permission of the start of feeding of the recording material for the N-th print instruction at timing of the value stored in said storing portion.

4. An image forming apparatus according to claim 2, wherein when said value for the (N-1)-th print instruction stored in said storing portion is larger than the value relating to the predetermined time, said controller sets th timing of permission of the start of feeding of the recording material for the N-th print instruction at timing after a lapse of the predetermined time.

5. An image forming apparatus according to claim 2, wherein said image forming apparatus causes said measuring portion to measure the temperature rising rate every print instruction and then causes said storing portion to store a value relating to the measured temperature rising rate.

6. An image forming apparatus according to claim 1, wherein the value relating to the temperature rising rate is a time.

7. An image forming apparatus according to claim 1, wherein when a difference between the value for the (N-1)-th print instruction and the value for the N-th print instruction exceeds a threshold, said controller corrects a target temperature of said fixing portion when the toner image is fixed on the recording material.

8. An image forming apparatus according to claim 1, wherein when a time difference between timing of input of the value for the (N-1)-th print instruction and timing of input of the value for the N-th print instruction exceeds a threshold, said controller sets the timing of the start of feeding of the recording material after the predetermined time elapses.

9. An image forming apparatus according to claim 1, wherein when a fluctuation range of measurement results of the temperature rising rate for a plurality of print instructions exceeds a threshold, said controller sets the timing of the start of feeding of the recording material after the predetermined time elapses.

10. An image forming apparatus according to claim 1, wherein said fixing portion includes a cylindrical film contactable to the toner image on the recording material and a heater configured to heat the toner image through said film in contact with an inner surface of said film.

11. An image forming apparatus according to claim 10, wherein said fixing portion includes a pressing roller configured to form a fixing nip, for nipping and feeding the recording material, between itself and said film in cooperation with said heater.

12. An image forming apparatus according to claim 11, wherein said detecting portion detects a temperature of at least one of said film, said heater and said pressing roller.

13. An image forming apparatus comprising:
an image forming portion configured to form a toner image on a recording material;
a fixing portion including a heater and configured to fix the toner image on the recording material by heating the toner image formed on the recording material;
a temperature detecting portion configured to detect a temperature of said fixing portion;
a measuring portion configured to measure, with said temperature detecting portion, a temperature rising rate of said fixing portion when the temperature of said fixing portion rises, upon receipt of a print instruction, to a predetermined temperature at which the toner image is fixable;
a storing portion configured to store a value relating to the temperature rising rate measured by said measuring portion; and
a controller configured to control feeding start timing of the recording material,
wherein said controller is capable of setting a case that a start of feeding of the recording material is permitted after a lapse of a predetermined time from a start of supply of electric power to said heater in response to a print instruction and a case that the start of feeding of the recording material is permitted, depending on the value stored in said storing portion, at timing before the lapse of the predetermined time.

14. An image forming apparatus according to claim 13, wherein said value for an (N-1)-th print instruction is stored in said storing portion, and
wherein when said value for the (N-1)-th print instruction is smaller than a value relating to the predetermined time, said controller sets timing of permission of a start of feeding of the recording material for an N-th print instruction at timing before a lapse of the roller time and depending on said value stored in said storing portion.

15. An image forming apparatus according to claim 14, wherein when said value for the (N-1)-th print instruction stored in said storing portion is smaller than the value relating to the predetermined time, said controller sets th timing of permission of the start of feeding of the recording material for the N-th print instruction at timing of the value stored in said storing portion.

16. An image forming apparatus according to claim 14, wherein when said value for the (N-1)-th print instruction stored in said storing portion is larger than the value relating to the predetermined time, said controller sets th timing of permission of the start of feeding of the recording material for the N-th print instruction at timing after a lapse of the predetermined time.

17. An image forming apparatus according to claim 14, wherein said image forming apparatus causes said measuring portion to measure the temperature rising rate every print instruction and then causes said storing portion to store a value relating to the measured temperature rising rate.

18. An image forming apparatus according to claim 13, wherein said fixing portion includes a cylindrical film contactable to the toner image on the recording material and a heater configured to heat the toner image through said film in contact with an inner surface of said film.

19. An image forming apparatus according to claim 18, wherein said fixing portion includes a pressing roller configured to form a fixing nip, for nipping and feeding the recording material, between itself and said film in cooperation with said heater.

20. An image forming apparatus according to claim 19, wherein said detecting portion detects a temperature of at least one of said film, said heater and said pressing roller.
